(19) United States
(12) Patent Application Publication
(10) Pub. No.: US 2008/0126868 A1
(43) Pub. Date: May 29, 2008

(54) System and method for storing embedded diagnostic test failure reports on a faulty component

(76) Inventors: David W. Murray, Windsor, CA (US); Kim Chung Thi Thanh, Rohnert Park, CA (US); Bruce A. Erickson, Santa Rosa, CA (US); David M. Gallegos, Albany, CA (US); Alan N. Wight, Petaluma, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/514,426

(22) Filed: Sep. 1, 2006

(51) Int. Cl. G06F 11/28

(52) U.S. Cl. 714/37; 714/E11.178

(57) ABSTRACT

A method is provided for performing a diagnostic test on a piece of equipment, the equipment including a plurality of components, each of the components including a diagnostic test result store. The method comprises executing a diagnostic test by means of a diagnostic apparatus embedded within the piece of equipment, determining, based on the results of the diagnostic test, that one of the components is diagnosed to be faulty, preparing a report of results of the diagnostic test within the diagnostic test store of the faulty component; and storing the report in a test report store on-board the diagnosed faulty component.

### BACKGROUND OF THE INVENTION

The present invention relates to diagnostic testing for electronic equipment.

Conventional diagnostic testing arrangements have involved coupling a test system, such as a production line Unix workstation, to an instrument or piece of equipment to be tested. Troubleshooting software applications, in the form of BASIC or C language programs or shell scripts, etc., reside within the test system.

When such troubleshooting software applications are executed, the test system, and the instrument to be tested, communicate through a communication interface. For instance, many such troubleshooting applications use an IEEE 488 General Purpose Interface Bus (GPIB) connection between the UNIX workstation and the instrument.

It would be advantageous to employ standard network communications for such diagnostic testing, obviating the need for a diagnostic-specific interface such as the GPIB and allowing for remote testing. It would also be advantageous to execute diagnostic testing on-board the equipment to be tested.

### SUMMARY OF THE INVENTION

A method is provided for performing a diagnostic test on a piece of equipment, the equipment including a plurality of components, each of the components including a diagnostic test result store. The method comprises executing a diagnostic test by means of a diagnostic apparatus embedded within the piece of equipment, determining, based on the results of the diagnostic test, that one of the components is diagnosed to be faulty, preparing a report of results of the diagnostic test within the diagnostic test store of the faulty component; and storing the report in a test report store on-board the diagnosed faulty component.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIGS. 1 and 2 are block diagrams showing a system for performing diagnostic testing of a piece of equipment, which is an environment within which an embodiment of the invention is practiced.

FIG. 3 is a flowchart showing an embodiment of the invention.

FIG. 4 is an example of a format for a diagnostic test report to be provided to the operator of the piece of equipment.

### DETAILED DESCRIPTION

A system embodying the invention includes self-contained embedded diagnostics for a piece of electronic equipment. Among other fields, such a system may be employed in a measurement apparatus for radiofrequency (hereinafter “RF”) systems.

Initial testing of factory-manufactured equipment before shipment to the user/customer may easily be performed. However, once a piece of equipment leaves the factory and a user begins using it, it is notoriously difficult to receive good failure data from the field. In such systems, it is desirable to be able to self-diagnose problems which can be solved by replacing components of the equipment, such as sub-assemblies, cables, etc., without requiring the use of external test and measurement equipment. When such a problem is diagnosed, service personnel not necessarily requiring great expertise or training, can replace the faulty component.

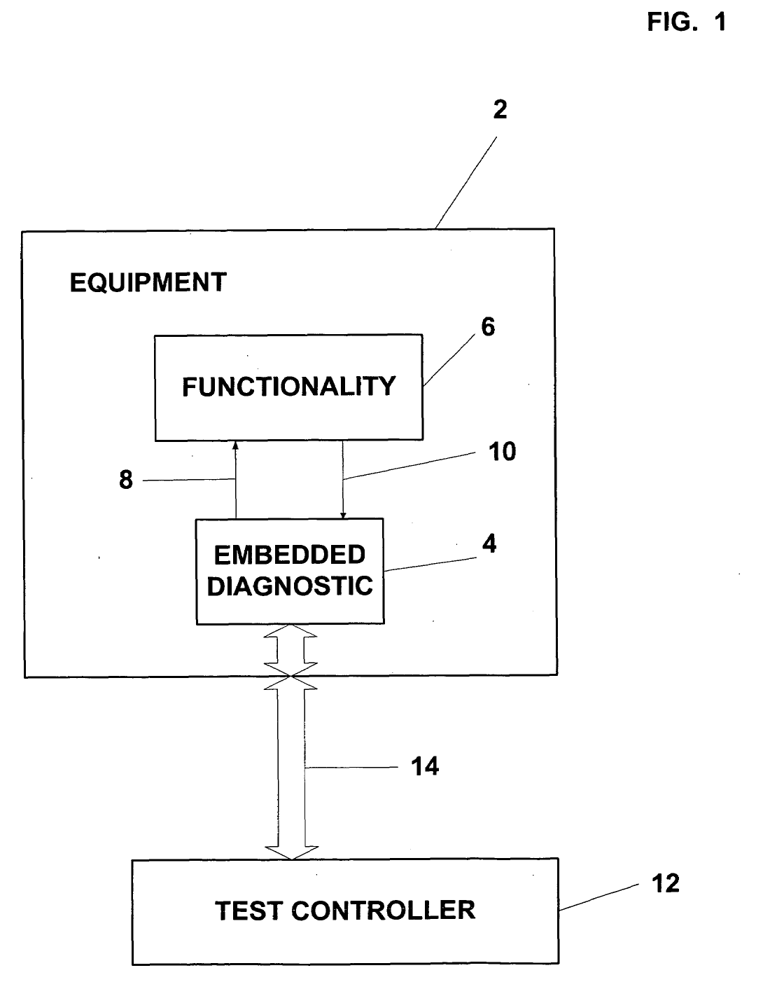

For instance, FIG. 1 is a schematic block diagram of a system in which a piece of equipment 2, which is to be tested, includes an embedded diagnostic apparatus 4. The equipment 2 has a general functionality 6, whose nature is not essential to the present invention but is characteristic of the type of equipment 2. The diagnostic apparatus 4 provides input stimulus signals to the functionality 6 through an input 8, and receives response signals through an output 10. Optionally, the diagnostic 4 can be controlled by an external test controller 12, through a communication link 14.

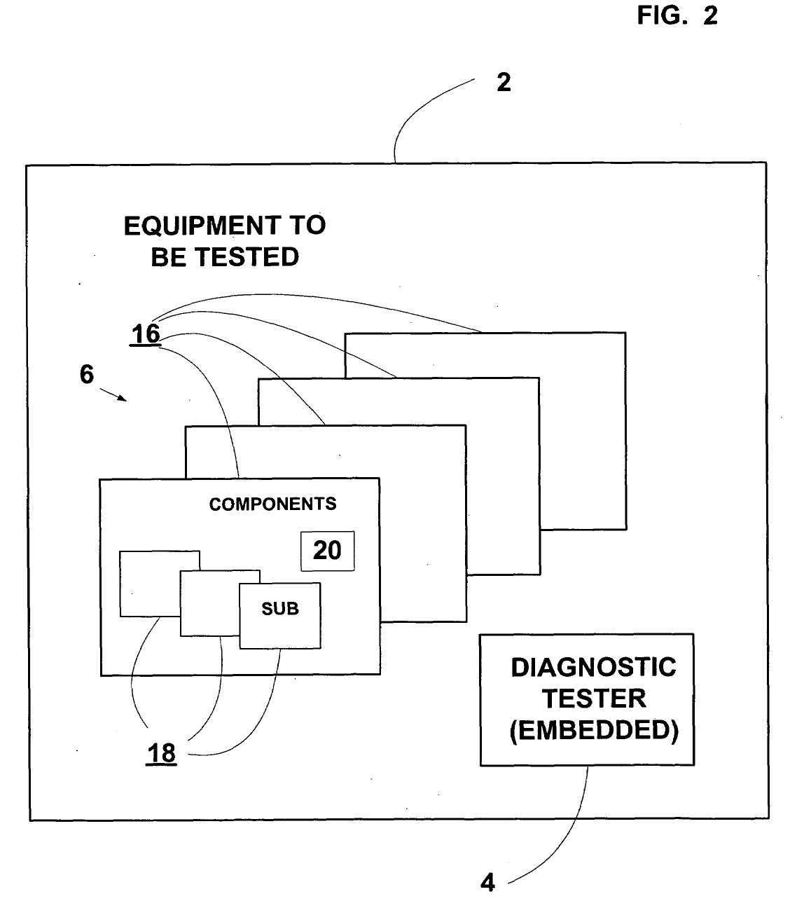

In FIG. 2, the equipment 2 is shown in more detail, with its functionality 6 comprising a variety of components, shown collectively and schematically as 16. The components 16 are made up of sub-components which, in the example of one of the components 16, are shown collectively and schematically as 18. The components 8, and their respective subcomponents 18, have various structures and functions suitable for the particular nature of the equipment 2.

Additionally, each component 16 contains a diagnostic test fault report store 20, such as an electrically erasable programmable read-only memory (EEPROM). As will be described in detail below, diagnostic test results are stored in the fault report store 20.

In the discussion which follows, the term “indicted” will be used to describe a component, sub-assembly, etc., of the equipment 2, for which a problem has been diagnosed. Also, the terms “component” and “communication component” will be used interchangeably, to refer broadly and without limitation to any sub-assembly, cable, interface, component, etc., within a communications system, for which a fault may occur. The term “fault” will refer to any problem that is, or can be, isolated within a particular component of the communication system. Finally, the term “device under test” or “DUT” will be used to refer to the equipment 2 to be tested.

A diagnostic performed by a system embodying the invention can identify an indicted component, a failing component, or the component most likely to fail or to have failed. Also, the particular nature of the fault or failure can be identified.

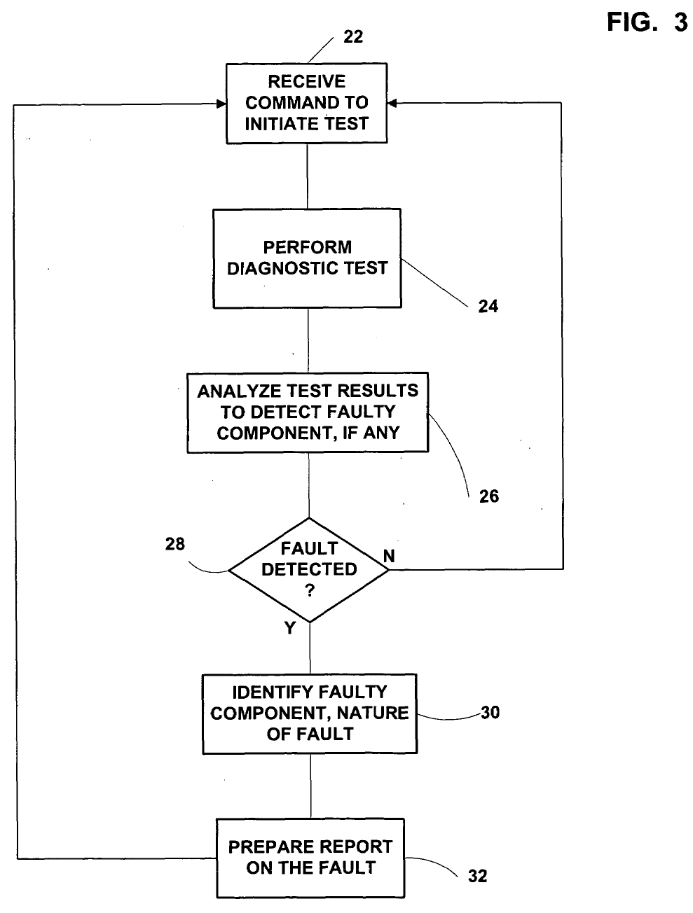

FIG. 3 is a flowchart showing operation of a diagnostic test apparatus such as that of FIGS. 1 and 2. Initially, a test command is received (22). Such a command can come from a user input interface on the equipment itself, via a remote command received over a network or other communication line coupled to the equipment, or from an automatic test scheduling and control apparatus.

Responsive to the test command, the test controller sends (24) a test signal to exercise the equipment 2, and to detect and obtain test information regarding how the various components of the equipment 2 are behaving. The detected test information is analyzed (26) to determine whether the components are functioning normally, or whether an abnormality that may be indicative of a fault or problem has been detected.

Based on that analysis, it is determined (28) first, whether a fault has been detected, and second, based on which test points show which abnormalities, which component seems to be faulty. If no fault is detected, the test apparatus idles or performs other functions until another test command (22) is received.

If a fault is detected, the faulty component, and the nature of the fault, are analyzed (30), and a report is prepared (32). The report is stored in the fault report store 20, and/or displayed or printed to the system operator (32), through a user interface, printer, display, etc. The report may also be transmitted to the remote test controller 12.

Analyzing (30) the faulty component and the nature of the fault can include multiple levels. That is, where a faulty component 16 includes multiple sub-components 18, the tests and the analysis of their results can make it possible to further isolate the fault to one of the sub-components 18.

The diagnostic application can identify the most likely failing sub-component 18, within a diagnosed faulty component 16, and provide to the EEPROM fault report store 20 of the faulty component 16 a report of the fault within the indicted component 16. Such fault report information, stored within the failure report store 20 of the faulty component 16, allows technicians to quickly repair faulty components, which conventionally would have accumulated as faulty components (sometimes called “dog board” piles) awaiting repair.

The suspect component can be loaded into a specially designated diagnostic system (sometimes called a “system mule”), and the EEPROM queried to gain insight as to the likely failure mechanism.

Alternatively, when a faulty component is shipped back to the factory or a service center, a system embodying the invention now provides a means of establishing how an instrument failed in service. The factory or appropriate user can use an embedded tool to read back the low-level sub-component failure detail from the fault report store 20. This aids in understanding the failure mechanisms of the component 20 under service conditions.

The report may be in a form that will direct the operator to replace the component believed to be faulty, such as a display or a printout. Where an operator does not necessarily have great expertise with the equipment but has facility with swapping components in and out, the report is sufficient to enable the operator to take action that will enable the equipment to keep on functioning.

The form and content of the report can be analogized to an incident in Arthur C. Clarke's science fiction novel 2001: A Space Odyssey. The HAL 9000 computer on board the spacecraft Discovery directed astronaut David Bowman to replace the AE-35 unit, which was reported to be faulty and, if it were to fail, would have disabled the communication link to Earth. Astronaut Bowman then performed an extravehicular activity to replace the AE-35 unit.

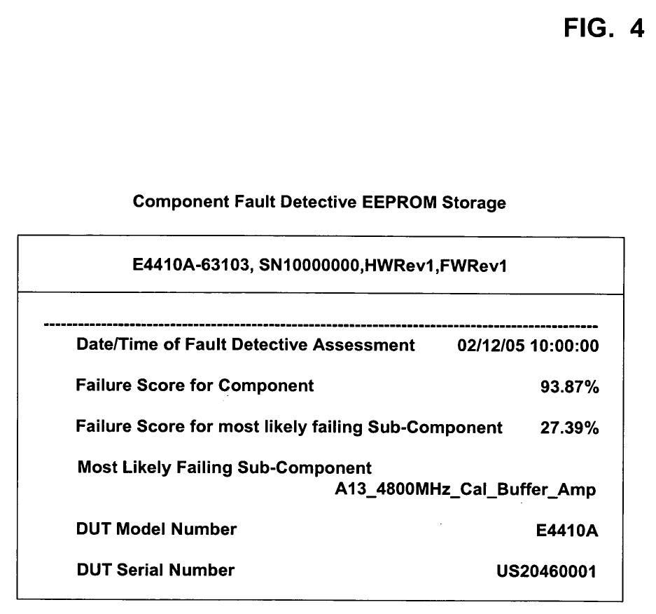

FIG. 4 is an example of the format of a fault report that could be generated and displayed by an embodiment of the invention. Substantially the same information can be stored in the fault report store of the faulty component, but in a format suitable for efficient storage, which would be understood by diagnostic test system programmers.

Optionally, the displayed report can include a header such as that shown within the box near the top of FIG. 3. The header might, for instance, include the vendor model number of the equipment. It might also include a logical name for the equipment, if a logical name may be assigned by the user of the equipment, or other identifying indicia that would be useful and convenient for the user. The header might also include a generic legend, such as that at the very top of FOG. 3, identifying that what is displayed is a fault diagnosis report which has also been entered into the component's fault report store, i.e., its EEPROM.

Information displayed in the report may include items such as those shown in the lower part of FIG. 3: (i) the date and time the diagnostic ran and the fault was diagnosed, (ii) a quantitative failure score for a component that has been diagnosed as faulty, (iii) test results of a sub-component within the diagnosed faulty component that is diagnosed as being the most likely location of the component's fault, (iv) the name, model number, or other descriptor, for the diagnosed sub-component, and (v) information identifying the equipment, i.e., the “device under test”, such as its model number and serial number, as well as other information also given in the report header (as discussed above).

Note that, where more than one sub-component within the faulty component may be faulty, the information in items (iii) and (iv), above, may be given multiple times for each of the sub-components likely to be faulty, for instance for every sub-component whose score is above a predetermined threshold.

Although the present invention has been described in detail with reference to particular embodiments, persons possessing ordinary skill in the art to which this invention pertains will appreciate that various modifications and enhancements may be made without departing from the spirit and scope of the claims that follow.

1. A method for performing a diagnostic test on a piece of equipment, the equipment including a plurality of components, each of the components including a diagnostic test result store; the method comprising:
executing a diagnostic test by means of a diagnostic apparatus embedded within the piece of equipment,
determining, based on the results of the diagnostic test, that one of the components is diagnosed to be faulty;
preparing a report of results of the diagnostic test within the diagnostic test store of the faulty component; and
storing the report in a test report store on-board the diagnosed faulty component.

2. A method as recited in claim 1, wherein preparing includes preparing a report that contains at least one of (i) a day and time when the diagnostic test was executed, (ii) the diagnosed faulty component, (iii) a failure score for the diagnosed faulty component, and (iv) a model number and serial number for the piece of equipment.

3. A method as recited in claim 1, wherein:
the method further comprises determining, based on the results of the diagnostic test, that a sub-component within the faulty component is likely to be faulty, and
the preparing a report of results includes preparing a report (i) that the diagnosed faulty component is faulty, and (ii) that the sub-component is likely to be faulty.

4. A method as recited in claim 3, wherein preparing includes preparing a report that contains information about at least one of (i) a day and time when the diagnostic test was executed, (ii) the diagnosed faulty component, (iii) a failure score for the diagnosed faulty component, (iv) a likely faulty sub-component of the diagnosed faulty component, (v) a failure score for the likely faulty [cub-component] sub-component, and (vi) a model number and serial number for the piece of equipment.

5. A method as recited in claim 1, further comprising providing the prepared report to a user of the equipment.

6. A method as recited in claim 5, wherein the providing includes one of (i) printing out the report, and (ii) displaying the report.

7. A method as recited in claim 1, wherein the executing includes executing the diagnostic test responsive to a command received from one of (i) a remote diagnostic test controller coupled to provide the command to the piece of equipment, and (ii) a user interface on the piece of equipment.

8. An apparatus for performing a diagnostic test on a piece of equipment, the equipment including a plurality of components, the apparatus comprising: diagnostic test results stores, one of the diagnostic test result stores disposed on each respective one of the components; and
a diagnostic apparatus, embedded within the piece of equipment, for determining, based on the results of the diagnostic test, that one of the components is diagnosed to be faulty, for preparing a report of results of the diagnostic test, and for storing the report within the diagnostic test results store of the faulty component.

9. An apparatus as recited in claim 8, the diagnostic apparatus prepares a report that contains at least one of (i) a day and time when the diagnostic test was executed, (ii) the diagnosed faulty component, (iii) a failure score for the diagnosed faulty component, and (iv) a model number and serial number for the piece of equipment.

10. An apparatus as recited in claim 8, wherein the diagnostic apparatus determines, based on the results of the diagnostic test, that a sub-component within the faulty component is likely to be faulty, and prepares a report (i) that the diagnosed faulty component is faulty, and (ii) that the sub-component is likely to be faulty.

11. An apparatus as recited in claim 10, wherein the diagnostic apparatus prepares a report that contains information about at least one of (i) a day and time when the diagnostic test was executed, (ii) the diagnosed faulty component, (iii) a failure score for the diagnosed faulty component, (iv) a likely faulty sub-component of the diagnosed faulty component, (v) a failure score for the likely faulty sub-component, and (vi) a model number and serial number for the piece of equipment.

12. An apparatus as recited in claim 8, further comprising a user interface for providing the prepared report to a user of the equipment.

13. A method as recited in claim 12, wherein the user interface includes one of (i) a printer interface for printing out the report, and (ii) a display interface for displaying the report.

14. An apparatus as recited in claim 8, wherein the diagnostic apparatus executes the diagnostic test responsive to a command received from one of (i) a remote diagnostic test controller coupled to provide the command to the piece of equipment, and (ii) a user interface on the piece of equipment.
